(19) United States
(12) Patent Application Publication
(10) Pub. No.: US 2009/0184989 A1
(43) Pub. Date: Jul. 23, 2009

(54) CONTROLLER

(75) Inventors: David Block, El Cerrito, CA (US); David Allen, Albany, CA (US); Karen Evans, San Bruno, CA (US); Frank Van Coppenolle, Sint-Lievens-Houtem (BE)

Correspondence Address: MARSHALL, GERSTEIN & BORUN LLP, 233 SOUTH WACKER DRIVE, 6300 SEARS TOWER, CHICAGO, IL, 60606-6357, US

(73) Assignee: DYMO, Sint-Niklaas (BE)

(21) Appl. No.: 12/016,747

(22) Filed: Jan. 18, 2008

(51) Int. Cl. B41J 29/38

(52) U.S. Cl. 347/5

(57) ABSTRACT

A controller arranged to provide print data to a print apparatus, said print data comprising an image to be printed on a disc, said image being such that at least one print parameter is determinable from said image when printed on said disc; receive said at least one print parameter; and control a subsequent printing operation on a disc based on said received at least one print parameter.

### FIELD OF THE DISCLOSURE

The present disclosure relates to a controller for use with a print apparatus, a printing arrangement, a method and a reference device for use with a disc.

### BACKGROUND

It is possible for users to record information or data on CDs (compact disc) and DVDs (digital versatile disc) either in the home or office environment. It is also common for relatively small batches of CDs or DVDs to be produced.

In response to this, a number of inkjet printers have been produced. These printers are either printers dedicated to printing on discs or printers which can be modified to print on a surface of the CD or DVD. Typically a tray is provided on which the disc is supported during printing.

It has been found that as inkjet printable CDs and DVDs have become more common, consumers have many more choices of which brand or type of inkjet printable discs to use. If an attempt is made to print on a non-inkjet compatible disc surface, the ink will simply coalesce into a number of droplets on the media surface. The ink will not dry and accordingly, the printing attempt will fail. Thus, printable discs have a surface on which an inkjet printer can print an image. This printable surface is provided with a specially treated top coat which will accept the inkjet inks.

However, this leads to a problem. Typically, the coating will not cover the entire top surface of the disc. Additionally, the coating will vary from one manufacturer to another and even between different lots produced by the same manufacturer.

Furthermore, generally, there are two types of CDs and DVDs available. The first category is the hub printable CD or DVD in which the coating will extend from near the outside perimeter to near the centre hole of the disc. The second broad category is the non-hub printable disc where the coating extends from near the outside perimeter but leaves a 20 to 40 mm area at the centre of the disc which is not coated.

These discs present a problem to the user. Without knowing the outside or inside radii of the coating it is possible to print on the non-coated section of the disc. This then leaves ink droplets which are easily smudged during normal handling or stacking, thereby ruining the printed image, transferring ink to fingers and hands and other complications.

To determine the correct printing area, it is necessary to print a number of test discs using trial and error in order to determine the full print area. However, this is a time consuming process in that a ruler is required and often it is necessary to try several test prints in order to get the desired result. This is wasteful of discs as well as time consuming.

As mentioned previously, the nature of the coating varies. This means that the ink absorption characteristics vary from disc to disc so colours may appear differently on different types of media. To obtain a desired colour it is necessary to print a number of different test discs and alter the density setting until the desired colour is obtained.

Furthermore, since the nature of these coatings varies from manufacturer to manufacturer, this means that the colour of the resulting image can vary. This is the result of the different interactions of the ink and the coating.

It is an aim of one or more embodiments of the present disclosure to address or at least mitigate one or more the problems provided above.

### SUMMARY OF THE DISCLOSURE

According to an aspect of the present disclosure, there is provided a controller arranged to provide print data to a print apparatus, said print data comprising an image to be printed on a disc, said image being such that at least one print parameter is determinable from said image when printed on said disc; receive said at least one print parameter; and control a subsequent printing operation on a disc based on said received at least one print parameter.

According to another aspect of the present disclosure, there is provided a printing arrangement comprising a printing apparatus and a controller arranged to provide print data to a print apparatus, said print data comprising an image to be printed on a disc, said image being such that at least one print parameter is determinable from said image when printed on said disc; receive said at least one print parameter; and control a subsequent printing operation on a disc based on said received at least one print parameter.

According to a further aspect of the present disclosure, there is provided a method comprising providing print data to a print apparatus, said print data comprising an image to be printed on a disc, said image being such that at least one print parameter is determinable from said image when printed on said disc; and controlling a subsequent printing operation on a disc based on said at least one print parameter determined from said image.

According to another aspect of the present disclosure, there is provided a reference device for use with a disc, said device being of a transparent material such that a disc can be viewed through said reference device, said reference device comprising a plurality of markings indicating position information.

According to another aspect of the present disclosure, there is provided a reference device for use with a disc, comprising a base and at least one cut-out in said base, said at least one cut-out indicating position information.

According to another aspect of the present disclosure, there is provided a controller arranged to provide print data to a print apparatus, said print data comprising an image to be printed on a disc, said image being such that at least one print parameter is determinable from said image when printed on said disc; receive said at least one print parameter; and control a subsequent printing operation on a disc based on said received at least one print parameter.

According to another aspect of the present disclosure, there is provided a computer readable medium having computer-executable components comprising a first computer executable component which when executed provides print data to a print apparatus, said print data comprising an image to be printed on a disc, said image being such that at least one print parameter is determinable from said image when printed on said disc; and a second computer executable component which when executed controls a subsequent printing operation on a disc based on said at least one print parameter determined from said image.

### BRIEF DESCRIPTION OF THE SEVERAL VIEWS OF THE DRAWING

For a better understanding of the present disclosure and as to how the same may be carried into effect, reference will now be made by way of example only to the accompanying drawings in which:

FIG. 1 shows a first test disc of the present disclosure;

FIG. 2 shows a second test disc of the present disclosure;

FIG. 3 shows a schematic view of a printing arrangement of the present disclosure

FIG. 4 shows a flow chart of a method of the present disclosure;

FIG. 5 shows a schematic view of a clear calibration tool of the present disclosure; and

FIGS. 6a to d show alternative reference discs of the disclosure.

### DETAILED DESCRIPTION OF THE PREFERRED EMBODIMENTS

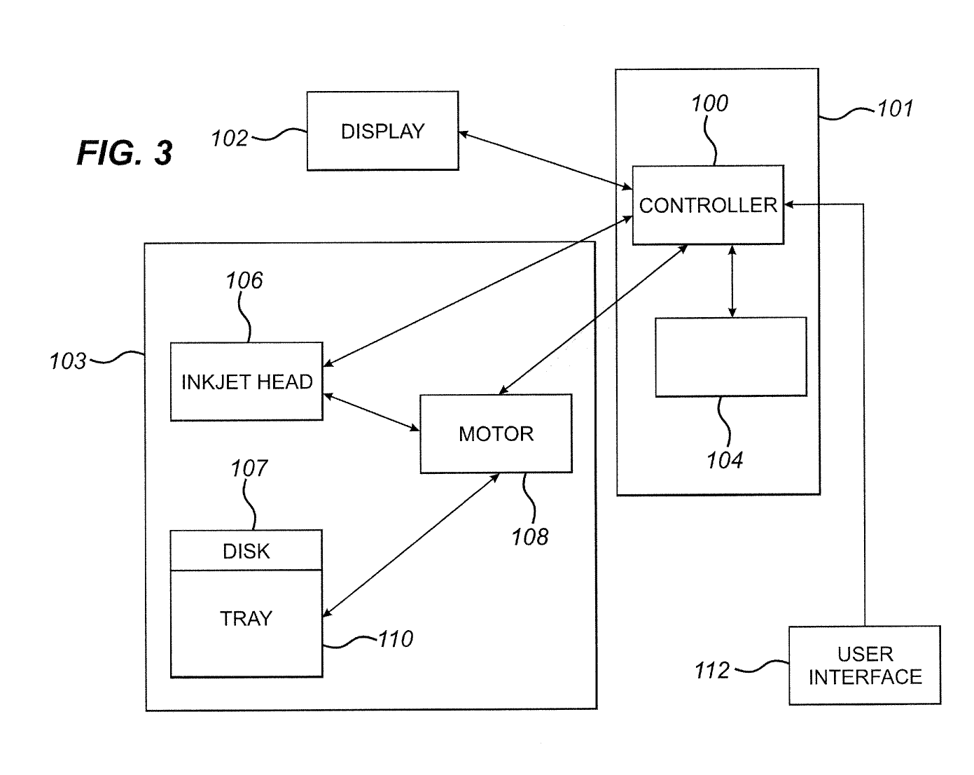

Reference is now made to FIG. 3 which schematically shows a printing arrangement embodying the present disclosure. The printing arrangement comprises a printing part 103. The printing part 103 comprises one or more inkjet heads 106. These inkjet heads are arranged to print an image on a surface of a CD 107 accommodated in a support tray 110. The printer 103 comprises, in this embodiment a motor 108. In this embodiment, the motor 108 is arranged to control the movement of the inkjet head to ensure that the correct location on the disc is printed. The motor is, in this embodiment, also connected to the tray 110. This tray 110 can be moved out, under the control of the motor, to allow the user to insert the disc into the tray 110 and is arranged to move the tray back inside the printer.

However, it should be appreciated that in some embodiments of the present disclosure, the tray 110 may be manually operated. In an alternative embodiment of the present disclosure, the inkjet head(s) remains stationary and the disc is instead moved relative to the inkjet head. In this scenario, the motor would control the movement of the tray or any other suitable support.

Thus, in some embodiments of the present disclosure, the disc is stationary during printing whilst the inkjet head moves. In alternative embodiments of the present disclosure, the inkjet head may be stationary and the disc moves relative to the inkjet head. In alternative embodiments of the present disclosure, there may be movement by both the inkjet head as well as the disc during printing.

The printer 103 is connected to a PC (personal computer) 101. This PC 101 comprises a controller 100 and a memory 104. The controller is effectively a microprocessor.

The printing system also comprises a display 102. Finally, a user interface 112 is provided. This user interface can take any suitable format. For example, the user interface may be a keyboard. Alternatively, the display may comprise a touch-screen and as such the display also provides the user interface.

The controller 100 is arranged to control the image displayed by the display 102. The user interface 112 interacts with the controller in order to input the required values (settings) for the inner and outer radii of the printing area as well as the print density. The display 102 may be controlled to display certain information or questions to assist the user in entering the required information. The values which are input by the user interface 112 are stored in the memory 104. The controller 100 is arranged to use the input settings in order to control the inkjet head. Additionally, the settings are also used to control the motor which can control the position of one or other or both of the inkjet head and the disc.

A test pattern which is to be printed is stored in the memory 104. When it is required to be printed, it is recalled from the memory 104 by the controller 100 which outputs print data for that test pattern to the inkjet head. The test pattern may be stored in the form of print data or may be converted into print data by the controller. The memory may store more than one test pattern. For example, if the printer is able to print on different sizes of disc, different patterns for the different sized discs may be stored. Alternatively the controller is able to modify the test pattern to take into account the size of disc which is to be printed on. Information on the size of the disc may be provided by means of the user interface. Alternatively, the tray may include one or more sensors which provide information on the size of the discs in the tray.

In one alternative, the printer has multiple test patterns for each size of the disc. The controller knows the size of the disc in the printer by input of the user or by detection, and the controller is arranged to display only these test patterns which are relevant for the size of the disc in the printer.

It should be appreciated that the controller 100 is shown as a single entity. The function of that controller 100 may be provided by one or more microprocessors.

In the embodiment shown in FIG. 3, the printer is a separate printer which is acting under the control of a PC. However, it should be appreciated that in some embodiments of the present disclosure, the printer may be a stand-alone printer. Thus, the user will interact directly with a user interface of the inkjet printer in order to cause a test pattern to be printed as well as to change to the various settings.

In some embodiments of the present disclosure, the printer may be connected to the PC but the user is able to change certain parameters, such as the print density and print area at the printer. In such an embodiment, it may be possible to additionally or alternatively cause a test pattern to be printed by interaction with the printer itself.

The embodiment described has a tray for supporting the disc. It should be appreciated that in alternative embodiments of the disclosure, that tray can be replaced by any other suitable support.

The above described arrangement has been described in the context of an inkjet printer. However, it should be appreciated that the other types of printer such as laser printers, thermal printers or the like can be used in embodiments of the disclosure.

Embodiments of the present disclosure allow a user to print a single test disc and from that single disc determine what the optimal inner and outer dimensions are for other discs of the same type and/or lot.

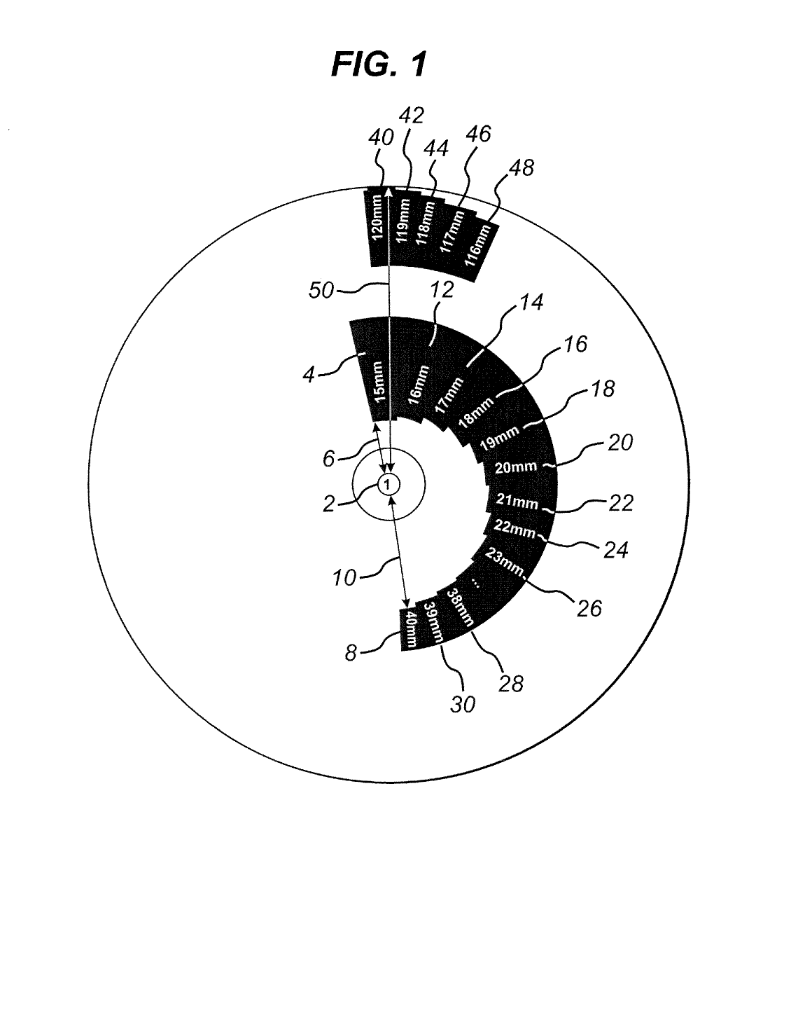

Reference is now made to FIG. 1 which shows a first test disc. This disc shown in FIG. 1 is printed when one disc of a batch is inserted into the printer. In the embodiment shown in FIG. 1, the test image which is printed on the disc consists of a series of images printed with different radii from the centre (hub) 2 of the disc. Accordingly, the first area 4 which is printed is such that the distance from the centre to the innermost edge of that area 4 is 15 mm. This distance is shown in FIG. 1 by reference number 6. Successive areas are printed around the centre point culminating in an area 8 which is 40 mm from the centre of the hub. This distance is marked 10. As can be seen from FIG. 1 successive areas 12 to 30 are printed. Each area is spaced from the centre of the hub by an additional 1 mm further away. Thus, area 12 is next to area 4. Area 4 is 15 mm away from the centre of the hub and area 12 is 16 mm from the centre of the hub. This is repeated so that each area is 1 mm further than the preceding area from the hub and 1 mm closer to the hub than the next area. For clarity, areas corresponding to 24 to 35 mm have not been shown.

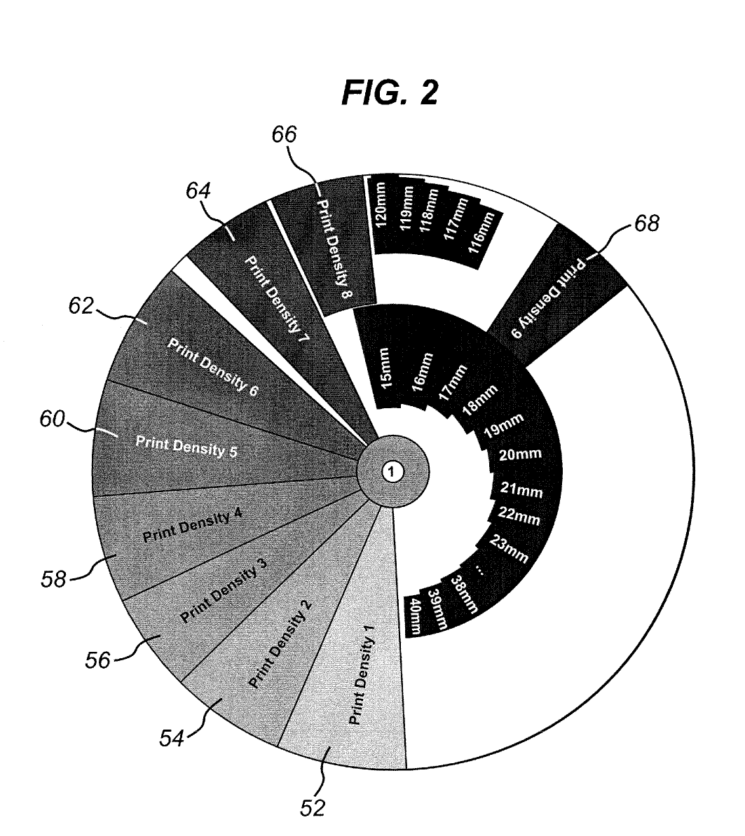

As can be seen from FIG. 2, to assist the user each area has printed thereon the numeric value associated with the distance from the centre of the hub to the innermost part of the area. The user selects the inner radii for which printing is possible as the area which is closest to the hub and which has been successfully printed, without smudging or the like.

Thus, the pattern which is printed will indicate to the user as to how close to the hub printing is possible. This then allows the user to set the inner radii setting of the printer.

A second set of areas are printed predetermined distances from the outermost part of the areas 40 to 48 to the hub. Thus, in the example shown in FIG. 1, the first area 40 is printed with the outermost edge of that area 40 being 120 mm from the hub. This distance is referenced 50. The adjacent area 42 is printed so that the distance from the outermost edge of that area 42 is 119 mm from the centre of the hub and so on. In the case of area 48 that is 116 mm from the centre of the hub. Again each area has printed thereon the distance from the centre of the hub.

In the same way as described with reference to the inner areas, the outer area which has been successfully printed and which is furthest from the hub is used to define the outer radii of the printing area.

By printing the image shown in FIG. 1 on the test disc, it is possible for the user to quickly see the usable printable area. Accordingly, although it may be possible that an image is printed on a non-printable area, this is readily apparent to the user and accordingly, the user can select the required print parameters. In other words, the user is able to set the minimum distance from the hub and the maximum distance from the hub for which printing is possible.

In the embodiment shown in FIG. 1, the areas are such that each adjacent area is spaced an additional 1 mm distance from the preceding adjacent area. This is by way of example only and the distance between adjacent areas may of course differ from that. It should also be appreciated that printed areas do not need to be ordered as shown in FIG. 1 such that each area is adjacent to the next largest area and the next smallest area. The differences between adjacent areas may be larger. In still another embodiment the areas may be completely mixed.

In the example shown, the areas are shown as touching. The areas of course do not need to be touching.

In the example shown, the minimum distance to the hub area has been shown as being between 15 mm and 40 mm. It should be appreciated that this is by way of example and in some embodiments of the disclosure, the test image which is printed may be at a distance less than 15 mm and/or greater than 40 mm. Likewise the maximum distances from the hub is shown as being between 120 and 116 mm. This is by way of example and other suitable ranges of distances may be used. It should be appreciated that the ranges of the inner and outer radii may include more or less values than the embodiment shown in FIG. 1. Alternatively, the test pattern may include settings for the user to define the range in which the minimum distances and maximum distances are printed, and/or the used step between consequent areas.

In the embodiment illustrated, the blocks shown in FIG. 1 are printed. In other words, for each distance, a small block is printed. It should be appreciated that in alternative embodiments of the present disclosure, concentric rings can alternatively be printed. The rings may have a specific labelled dimension printed on the test disc. It should be appreciated that the concentric rings may of course only extend over part of the radius of the disc and thus only be arcs. The arcs may be all provided in a common area or to improve readability, the odd distances may be provided in one part of the disc with the even distances from the hub provided in a separate part. It is of course possible to have the arcs staggered round the ring to provide a spiral type effect. Any other suitable layout is of course possible.

Instead of the areas shown in FIG. 1, radial lines may be printed. These radial lines will be separated from each other, rather than touching each other. For example, this may be done for every 20° degree of arc by way of example only. It should be appreciated that in the alternative embodiments, any other designs elements which extend across the expected range of the inner and outer radii can be provided.

In preferred embodiments of the present disclosure, the printed elements such as arcs concentric rings, areas, radial lines are individually labelled so that it is possible to directly read proper settings for the inner and outer radii of the print areas.

The step size can be in any desired units, be it metric or imperial. In preferred embodiments of the present disclosure, the graduations are selected to be in unit millimetres. Of course, the graduations can be of other sizes, such as half-millimetre, two of millimetres or other units. However, in preferred embodiments of the present disclosure, having unit millimetre changes between different areas provided an easy way of interpreting a radius within less than half a millimetre.

In use, when the design is printed, the user can see that the print result has lines or other measuring marks that are beyond the coating and adjacent lines or measuring marks that are fully contained within the coating. By reading these values of the outer circumference and the inner circumference, the user will be able to determine the appropriate setting to use when printing future discs from the same media. Using measuring references that are adjacent allows the user to interpolate between two marks and decide what optimal values.

Reference is now made to FIG. 2 which shows a second embodiment of the disclosure. In this embodiment, there are provided a series of printed colour areas, each area being printed in the same colour but using different print densities. By printing various shades of particular colour, the user can determine what density settings will work for a particular media type

In FIG. 2, areas 52 to 68 are each printed. One single colour is used, in one embodiment of the present disclosure, with each area printed with a different print density. Accordingly, the first area 52 is printed with the lower print density whilst the last area, area 68 is printed with the highest print density. The user is provided with the colour swatch which contains a required sample of that same colour which is used as the test print. The user is able to match the separately provided colour swatch with one of the printed areas. From that, the user is able to select the print density which provides the closest setting. The user can then select the required print density setting.

In preferred embodiments of the present disclosure, not only are the colours with a different intensity printed but also information overwriting that the particular colour indicating the density of that colour is also provided.

In the embodiment shown in FIG. 2, this is done in combination with the pattern which is used to determine the inner and outer radii for printing.

In the embodiment shown in FIG. 2, a single colour is used. That colour can take any suitable form. However, in alternative embodiments of the present disclosure, two or more colours may be printed with differing print densities.

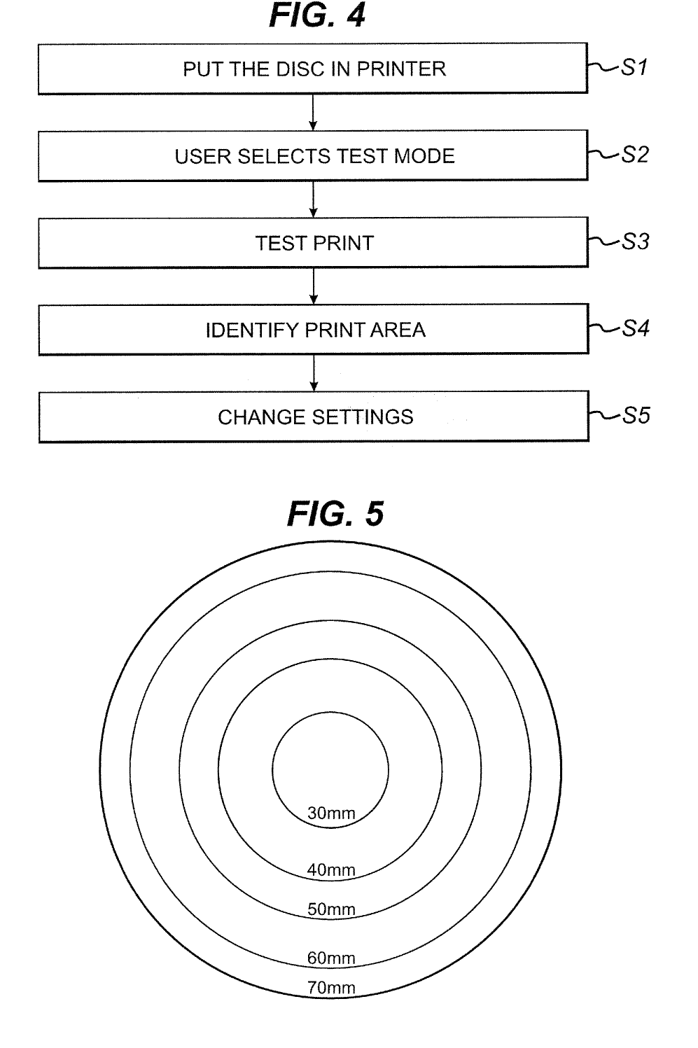

Reference is now made to FIG. 4 which shows a flow diagram of a method embodying the present disclosure.

In the first step S1, the user puts a disc in the appropriate tray of a printer.

In step S2, the user selects, via appropriate user interface, a test printing mode.

In step S3, the printer prints a test mode disc.

In step S4, the user looks at the printed test disc and decides the inner and outer radii for printing. If the test disc is as shown in FIG. 2, the user will also use a colour swatch and compare that to the different print density areas to identify the required print density. Alternatively, the user can simply select one of the print densities by eye.

In step S5, the user changes the printer settings to reflect the selected inner and outer radii for the print area as well as the print density.

The user is then able to print successfully on other discs of the same batch or the like using the defined print area and print density.

One modification, the user is able to store the select settings under a suitable name so that if the user uses a disc of the same type in the future, those settings can be recalled. More than one set of settings may be stored.

It should be appreciated that embodiments of the disclosure can be at least partially implemented by a computer program. For example, embodiments of the present disclosure may be provided as part of application software. Accordingly, embodiments of the present disclosure may be provided in the form of a computer program which run on a processor allow the processor to control a printer in order to print a test pattern and additionally allow a user to select settings including inner and outer print radii and print density.

It should be appreciated that embodiments of the present disclosure have been defined in terms of printing between an area defined by an inner radii and outer radii. It should be appreciated that any other suitable method can be used for defining the printable area on a disc.

Reference is now made to FIG. 5. FIG. 5 shows a reference disc on which a pattern similar to that shown in FIG. 1 is either pre-printed or printed using the printer. This disc is transparent so that an underlying disc can be viewed therethough. In the latter case, this is assuming that the disc is provided with a suitable coating which allows an image to be printed thereon. This pre-printed disc then acts as a reference disc. Accordingly, when a user uses the first disc in a batch, he places the clear reference disc over that disc. The user can then see the inner and outer radii of the coating, reads those values from the clear disc template and use that to control the printing area. The markings can take any suitable form, as set out above.

By way of example only, the arrangement of FIG. 5 shows successive concentric circles, each corresponding to a different distance from the hub. The arrangement shown in FIG. 5 is schematic and shows the circles with a spacing of 10 mm. In some embodiments, the circles may have a much smaller spacing for example a mm or the like. For examples of spacing size, reference is made to the embodiment of FIG. 1. Similar spacing sizes mentioned in the discussion in relation to FIG. 1 may also be used in this embodiment.

It should be noted, that in one embodiment, an the image discussed in relation to FIG. 1 could be a provided as a pre-printed, image on a clear disc in the same way as that in FIG. 5.

In one modification to the embodiment shown in FIG. 5, graduation marks may be provided between the lines to indicate intermediate sizes.

It should be appreciated that embodiments of the disclosure may have many more circles than shown in FIG. 5.

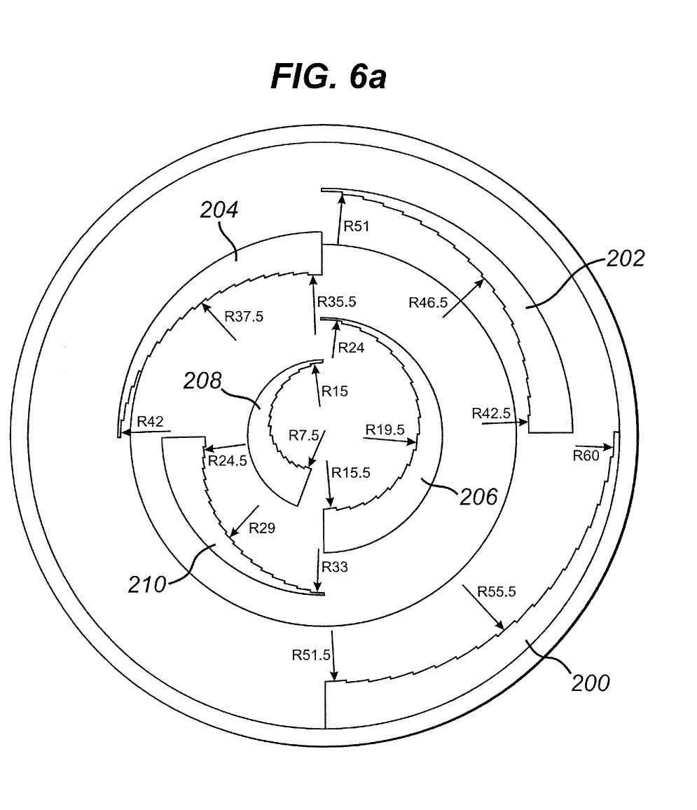

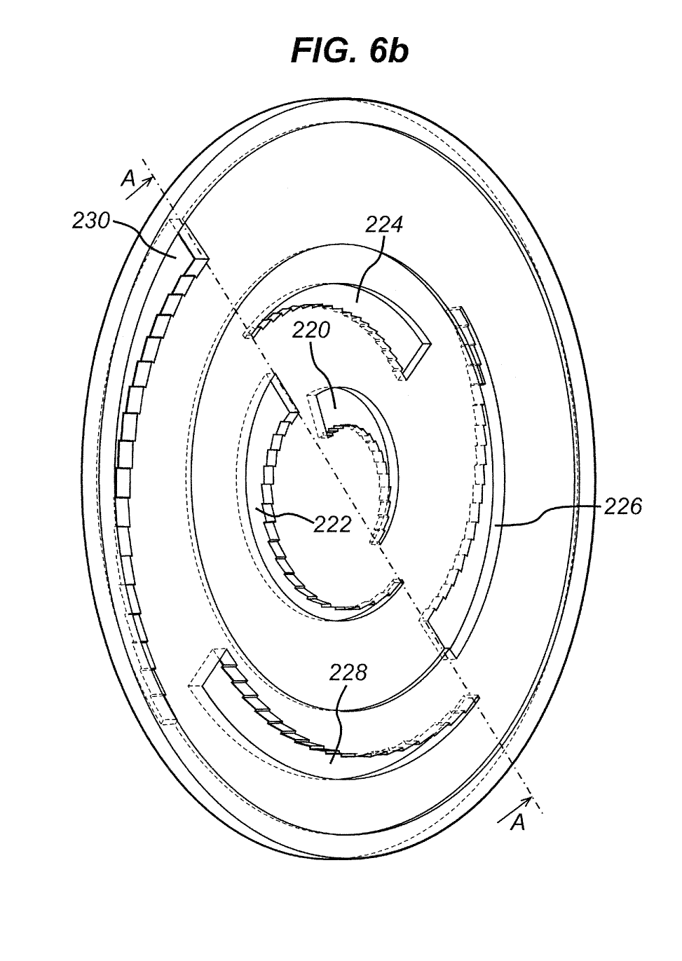

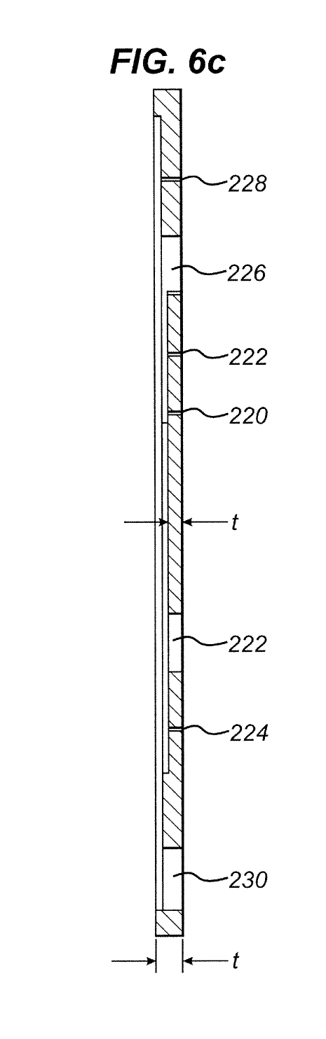

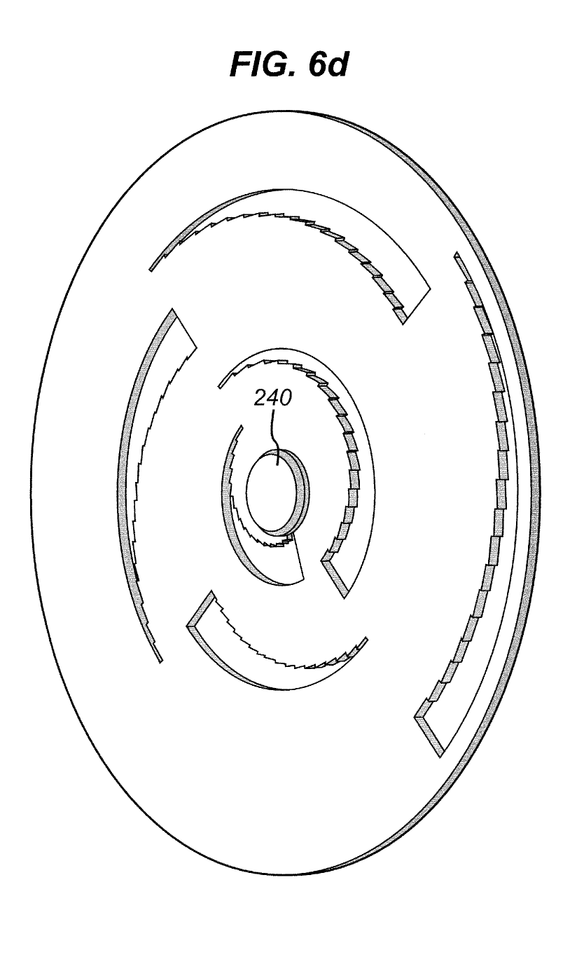

Reference is now made to FIG. 6 which shows alternative embodiments for a reference disc. It should be appreciated that the pattern may be defined on the disc using techniques alternative to or in addition to the printing described previously. For example, the pattern may be in the form or a relief or moulded pattern which may for example be formed by the shape of an injection mould. For example the disc may be moulded to have a relief or a pattern of open areas. This may mean that the disc may not be transparent. In yet another alternative, a pattern could be etched on a transparent or clear disc of plastics or glass.

In yet another embodiment, the pattern may be at least partially defined by a cut-out pattern.

In one alternative, the reference part is a part on which the disc can be positioned. The positioning of the disc on the reference part can be done via the hub (central hole) of the disc. The reference part has a central projection on which the disc can be positioned. The coating surface of the disc has to be positioned towards the surface of the reference part. The inner and outer radii can be read on the reference part on the side of the reference part opposite to the central projection. Alternatively or additionally, the positioning of the disc on the reference part can be done by the outer edge of the disc on the reference part. The reference part may be designed such that different sizes of discs can be positioned with their outer edge on the same reference part.

Reference is made to FIGS. 6a to 6d which show some further examples of a reference part.

Referring first to FIG. 6a, this shows a clear reference part with a series of gauges printed on the disc. These are similar to those printed in the embodiment described in relation to FIG. 1. In this example, there are six different gauges 200 to 210. Each gauge is appropriate for a subset of radii. For example, the innermost gauge 208 provides measurement information for radii of 7.5 mm to 15 mm. The second innermost gauge 206 provides measurement information for radii of 15.5 mm to 24 mm. In this embodiment, the gauges provide a continuous range of values from 7.5 mm to 60 mm. However in alternative embodiments of the disclosure, the gauges can be cover discontinuous ranges. In one embodiment one gauge can be provided for the external disc diameter and one gauge can be provided for the internal disc diameter.

More or less than six gauges can be provided. It should be appreciated that in this embodiment the step size used by each gauge is 0.5 mm. Different step sizes can be used in different embodiments. Additionally different step sizes may be used by different gauges. By way of example only, the step size for the larger radii may be larger than that for smaller step sizes.

In an alternative, a single gauge may be used with the entire range of values.

Reference is made to FIG. 6b which shows a variation of the embodiment shown in FIG. 6a. In this embodiment, the gauges 220-230 are similar to those described in relation to FIG. 6a but are provided by cut-out portions. As the gauges are provided by cut-out portions, the reference disc can be made either or a transparent or an opaque material.

Reference is made to FIG. 6c which is a cross-section along line A-A of FIG. 6b. As can be seen the thickness t increases as the radius of the disc increases. In alternative embodiments of the disclosure, the thickness of the reference disc is constant across the disc.

Reference is made to FIG. 6d. Any of the embodiments previously described may be modified to include a hub portion 240. In the embodiment shown in FIG. 6d, the hub portion is a raised circular portion rising above the plane of the disc. This hub portion may assist in the positioning of the disc with respect to the reference disc. In alternative embodiments of the disclosure, the hub portion may be provided by a hole extending through the reference disc. In yet another alternative embodiment of the disclosure, the hub portion may comprise a central rod extending from the underside of the reference disc which is able to receive the printed disc thereon to retain the printed disc in position relative to the reference disc.

It should be appreciated that alternative embodiments of the disclosure may combine various different features described in relation to the different examples.

What is claimed is:

1. A controller arranged to:
provide print data to a print apparatus, said print data comprising an image to be printed on a disc, said image being such that at least one print parameter is determinable from said image when printed on said disc;
receive said at least one print parameter; and
control a subsequent printing operation on a disc based on said received at least one print parameter.

2. A controller as claimed in claim 1, wherein said print parameter comprises print density information.

3. A controller as claimed in claim 2, wherein said image comprises a plurality of regions, said print data for printing each of said regions with a different print density.

4. A controller as claimed in claim 3, wherein each of said regions comprises the same color.

5. A controller as claimed in claim 3, configured to receive print density information and to control a subsequent printing operation on a disc based on said received print density information.

6. A controller as claimed in claim 1, wherein said print parameter comprises print area information

7. A printing arrangement comprising a printing apparatus and a controller arranged to:
provide print data to a print apparatus, said print data comprising an image to be printed on a disc, said image being such that at least one print parameter is determinable from said image when printed on said disc;
receive said at least one print parameter; and
control a subsequent printing operation on a disc based on said received at least one print parameter.

8. A printing arrangement as claimed in claim 7, wherein said printing apparatus comprises an inkjet printer.

9. A method comprising:
providing print data to a print apparatus, said print data comprising an image to be printed on a disc, said image being such that at least one print parameter is determinable from said image when printed on said disc; and
controlling a subsequent printing operation on a disc based on said at least one print parameter determined from said image.

10. A method as claimed in claim 9, wherein said print parameter comprises a print density parameter.

11. A method as claimed in claim 10, wherein said image comprises a plurality of regions, each of said regions being printed with a different print density.

12. A method as claimed in claim 11, wherein each of said regions comprises the same color.

13. A method as claimed in claim 9, comprising printing said image on a disc.

14. A method as claimed in claim 13, wherein said disc comprises a CD or a DVD.

15. A method as claimed in claim 9, wherein said disc has a first area on which an image is printable and a second, non printable area,

16. A method as claimed in claim 14, wherein said first area is provided by a coating.

17. A method as claimed in any of claim 9, wherein said print apparatus comprises a printer.

18. A method as claimed in claim 17, wherein said printer comprises an inkjet printer.

19. A reference device for use with a disc, said device being of a transparent material such that a disc can be viewed through said reference device, said reference device comprising a plurality of markings indicating position information.

20. A reference device for use with a disc, comprising:
a base; and
at least one cut-out in said base, said at least one cut-out indicating position information.

21. A reference device as claimed in claim 20, wherein said reference device is one of opaque and transparent.

22. A reference device as claimed in claim 19 or 20, wherein said position information is information indicative of respective distances from a reference position.

23. A reference device as claimed in claim 22, wherein said reference position is a hub position.

24. A reference device as claimed in claim 19, wherein said markings are provided with associated distance information.

25. A reference device as claimed in claim 19, wherein said markings comprises at least one of a: a cut-out pattern, a print pattern; and a relief pattern.

26. A reference device as claimed in claim 22, wherein said reference position is an outer edge of the disc.

27. A reference device as claimed in claim 19 or 20, wherein said reference device comprises a guiding element for an outer edge of the disc.

28. A controller arranged to:
provide print data to a print apparatus, said print data comprising an image to be printed on a disc, said image being such that at least one print parameter is determinable from said image when printed on said disc;
receive said at least one print parameter; and
control a subsequent printing operation on a disc based on said received at least one print parameter.

29. A computer readable medium having computer-executable components comprising:
a first computer executable component which when executed provides print data to a print apparatus, said print data comprising an image to be printed on a disc, said image being such that at least one print parameter is determinable from said image when printed on said disc; and
a second computer executable component which when executed controls a subsequent printing operation on a disc based on said at least one print parameter determined from said image.
